(19) United States
(12) Patent Application Publication
(10) Pub. No.: US 2010/0112522 A1
(43) Pub. Date: May 6, 2010

(54) Mesh Plate for Dental Implant and Dental Implant Structure Having the Same

(76) Inventor: Oh Dal Kwon, Daegu (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/596,275

(22) PCT Filed: Apr. 16, 2008
(86) PCT No.: PCT/KR2008/002153

§ 371 Date: Oct. 16, 2009

(30) Foreign Application Priority Data
Apr. 17, 2007 (KR) 10-2007-0037238

(51) Int. Cl. A61C 8/00

(52) U.S. Cl. 433/174

(57) ABSTRACT

Provided is a dental implant structure for recovering or improving function of a lost or damaged tooth. A mesh plate 1 for a dental implant with a plurality of holes 4 is loaded and fixed on an alveolar bone from which a tooth is lost. A barrier 9 for preventing proliferation of an epithelium and a gingival connective tissue covers the mesh plate 1 at a predetermined height from the mesh plate 1. Then, an alveolar bone can be regenerated from a blood clot flowed through the plurality of holes into a space defined by the mesh plate 1 and the barrier 9. As such, the mesh plate 1 can be strongly fixed to the alveolar bone with the help of the regenerated alveolar bone. Furthermore, an upper implant structure fixed on an abutment 2 protruding from the mesh plate 1 can be strongly fixed to the alveolar bone.

### TECHNICAL FIELD

The present invention relates to a dental implant structure, and more particularly, to a mesh plate for a dental implant and a dental implant structure having the same.

### BACKGROUND ART

A dental prosthesis is a treatment for recovering or improving function of a lost or damaged tooth by a crown bridge, an implant and the like. The implant restoration is a treatment for replacing a lost tooth by an artificial tooth by installing a fixture in an alveolar bone and fitting the artificial tooth on an abutment combined with the fixture.

However, installing the fixture is difficult when the alveolar bone is lost severely or when the location where the fixture is to be installed is close to a mandibular nerve or a maxillary sinus.

Therefore, various techniques have been performed to aid the installation of the fixture. Such techniques include implanting artificial bone or autogenous bone in the lost alveolar bone and splitting the alveolar bone, as well as a maxillary sinus lift technique and a nerve reposition technique of displacing a mandibular nerve before installing a fixture. However, such techniques are so complex, have a high risk, and need long performance time.

Furthermore, the fixture often can not be installed in a normal direction due to specific conditions of the alveolar bone. Consequently, a novel dental implant structure capable of overcoming these drawbacks is highly required.

### DISCLOSURE OF INVENTION

### Technical Problem

The above described drawbacks of the typical implant structure are due to the fact that an upper implant structure is supported only by the fixture installed in the alveolar bone. Accordingly, the dental prosthetic structure requires so strong alveolar bone as to support the fixture.

Accordingly, there have been proposed various difficult techniques such as implanting artificial bone or autogenous bone in the lost alveolar bone, splitting the alveolar bone, a maxillary sinus lift technique, and a nerve reposition technique of displacing a mandibular nerve before installing a fixture.

According to the present invention, the upper implant structure is supported by a mesh plate for a dental implant fixed on the alveolar bone, instead of the fixture installed in the alveolar bone. Consequently, the above described drawbacks of the typical implant structure can be overcome.

### Technical Solution

Embodiments of the present invention are directed to a mesh plate for a dental implant, which has a plurality of holes and is configured to be loaded on an alveolar bone from which a tooth is lost, and a dental implant structure having the mesh plate.

One or more abutments on which an upper implant structure is to be fixed may protrude from a top surface of the mesh plate.

A barrier for preventing proliferation of an epithelium and a gingival connective tissue may cover the mesh plate at a predetermined height from the mesh plate to facilitate regeneration of an alveolar bone from a blood clot of an alveolar bone flowed upward through the plurality of holes.

The mesh plate with the plurality of holes is loaded on the alveolar bone from which a tooth is lost. The barrier covers the mesh plate at the predetermined height from the mesh plate to form a predetermined space. Then, an alveolar bone is regenerated from the blood clot flowed into the space. As time passes, the regenerated alveolar bone covers the mesh plate to fix the mesh plate in an alveolar bone. Then, the upper implant structure is fixed on the abutment. Consequently, the upper implant structure can be supported by the regenerated alveolar bone and the mesh plate fixed in the regenerated alveolar bone.

On the mesh plate, the abutment may be formed in a body or detachably.

In order to fix the implant structure more strongly, a fixture may protrude from a bottom of the mesh plate so that the fixture is inserted and fixed in a bore formed in the alveolar bone. In addition, a plurality of wedges 12 with a sharp tip may protrude from the bottom of the mesh plate to penetrate into the alveolar bone, so as to fix the implant structure more strongly, and induce bleeding and thus generate a blood clot in a guided bone regeneration (GBR).

### Advantageous Effects

According to embodiments of the present invention, a mesh plate for a dental implant is loaded on an alveolar bone. The mesh plate may be provided with a fixture protruding from a bottom surface of the mesh plate so that the fixture is inserted and fixed in a bore formed in the alveolar bone. The mesh plate may be covered with a regenerated alveolar bone. Consequently, a dental implantation can be performed on a gingiva without a significant risk.

In addition, the dental implantation can be performed without a significant risk even when the alveolar is lost severely or the location where the fixture is to be installed is close to a mandibular nerve or a maxillary sinus. Time for performing the dental implantation can be significantly reduced, and difficulty of the initial fixation also can be overcome.

Further, the implant structure can be installed at an optimum position according to specific oral conditions especially when recovering a lost upper tooth.

A bore in the alveolar bone, if required, can also be formed at a position of an optimum bone quality. Furthermore, contrary to the typical implant structure, the fixture of the mesh plate according to the embodiments of the present invention does not need to be formed just below the abutment.

### BRIEF DESCRIPTION OF THE DRAWINGS

FIG. 1 illustrates a perspective view of a mesh plate for a dental implant loaded on an alveolar bone according to an embodiment of the present invention.

FIG. 2 illustrates an upper perspective view of a mesh plate for a dental implant according to an embodiment of the present invention.

FIG. 3 illustrates an upper perspective view of a mesh plate for a dental implant according to an embodiment of the present invention.

FIG. 4 illustrates a lower perspective view of a mesh plate for a dental implant according to an embodiment of the present invention.

FIG. 5 illustrates a lower perspective view of a mesh plate for a dental implant provided with a fixture according to an embodiment of the present invention.

FIG. 6 illustrates a lower perspective view of a mesh plate for a dental implant provided with a plurality of wedges with a sharp tip according to an embodiment of the present invention.

FIG. 7 illustrates a cross-sectional view of a mesh plate according to an embodiment of the present invention.

FIG. 8 illustrates a method for inserting plate-fixing screws through a mesh plate according to an embodiment of the present invention.

FIG. 9 illustrates a method for inserting barrier-fixing screws through a barrier into a barrier support of a mesh plate according to an embodiment of the present invention.

FIGS. 10 and 11 illustrate a method for installing a mesh plate on an alveolar bone according to an embodiment of the present invention.

FIG. 12 illustrates a method for installing a mesh plate without a fixture according to an embodiment of the present invention.

FIG. 13 illustrates a method for installing a mesh plate with a fixture on an alveolar bone in which a bore is formed according to an embodiment of the present invention.

FIG. 14 illustrates an upper perspective view of a mesh plate with two abutments formed thereon according to an embodiment of the present invention.

FIG. 15 illustrates a perspective view of a gingiva after installing a mesh plate and performing a suture according to an embodiment of the present invention.

FIG. 16 illustrates a method for fixing an upper implant structure on an abutment according to an embodiment of the present invention.

### MODE FOR THE INVENTION

Hereinafter, a mesh plate for a dental implant and a dental implant structure having the mesh plate in accordance with the present invention will be described in detail with reference to the accompanying drawings.

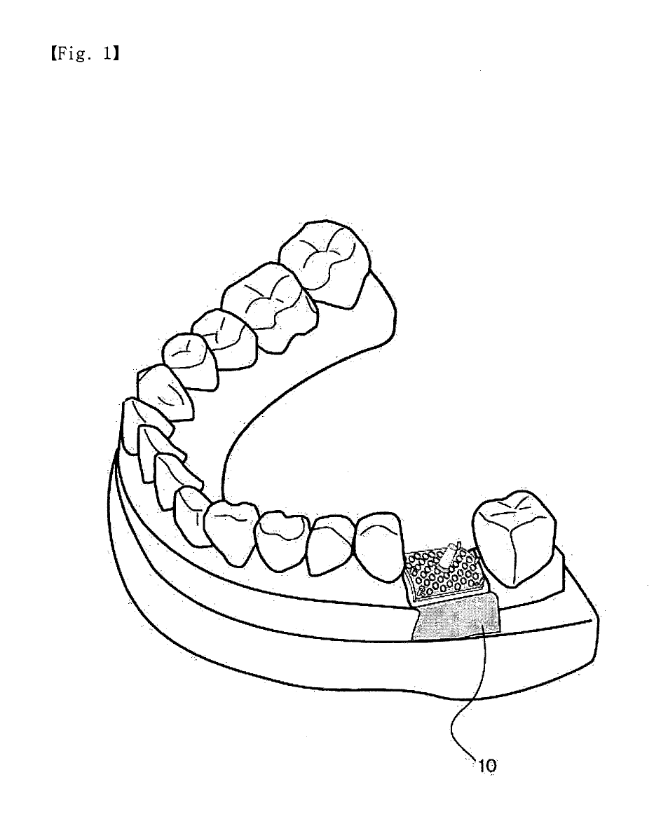

FIG. 1 illustrates a perspective view of a mesh plate 1 for a dental implant loaded on an alveolar bone according to an embodiment of the present invention.

A dental implant structure according to the embodiment of the present invention includes a mesh plate 1 with a plate-fixing hole 3 and a hole 4, an abutment 2 and a barrier support 5. The dental implant structure may further include a reinforcement 51, a fixture 6, a plate-fixing screw 7, a barrier-fixing screw 8, a wedge 12 and a barrier 9 for preventing proliferation of an epithelium and a gingival connective tissue. The barrier 9 is supported by the barrier support 5, at a predetermined distance from the mesh plate 1.

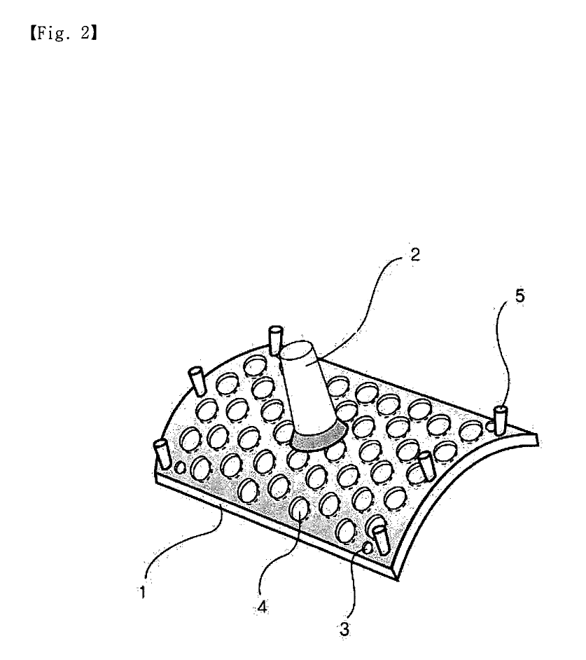

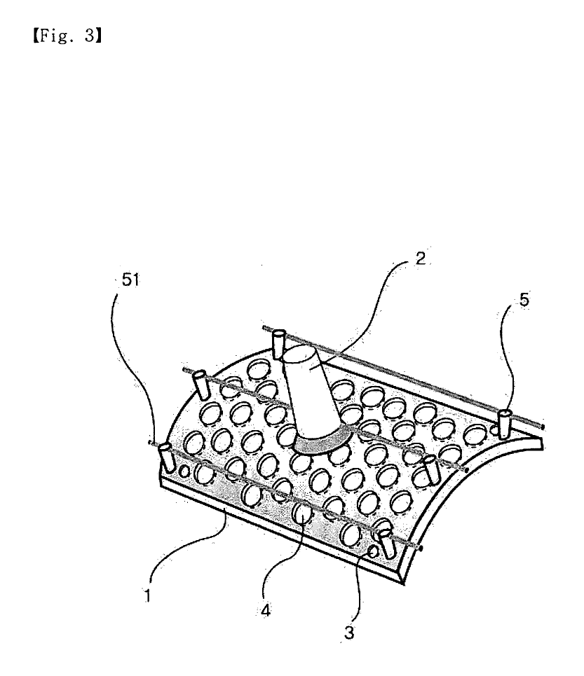

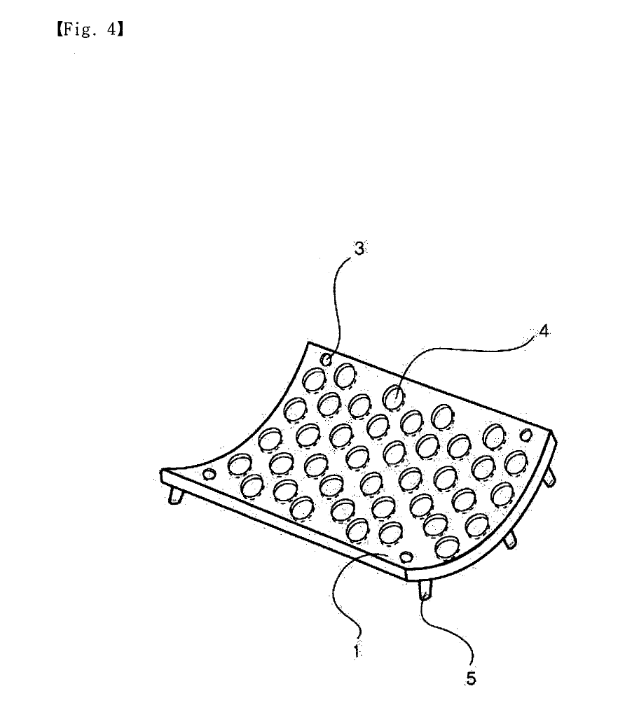

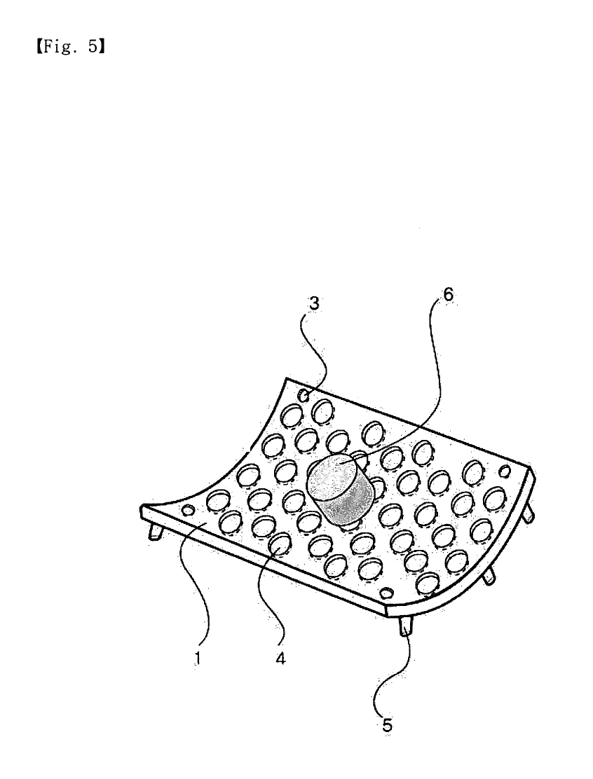

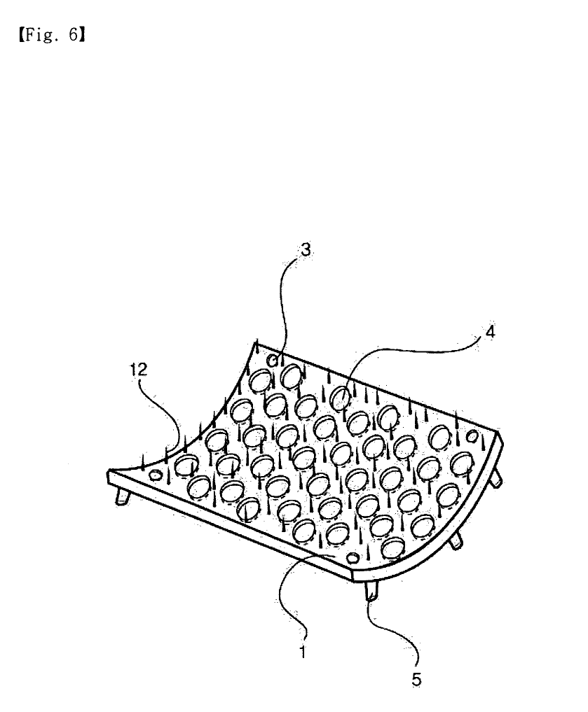

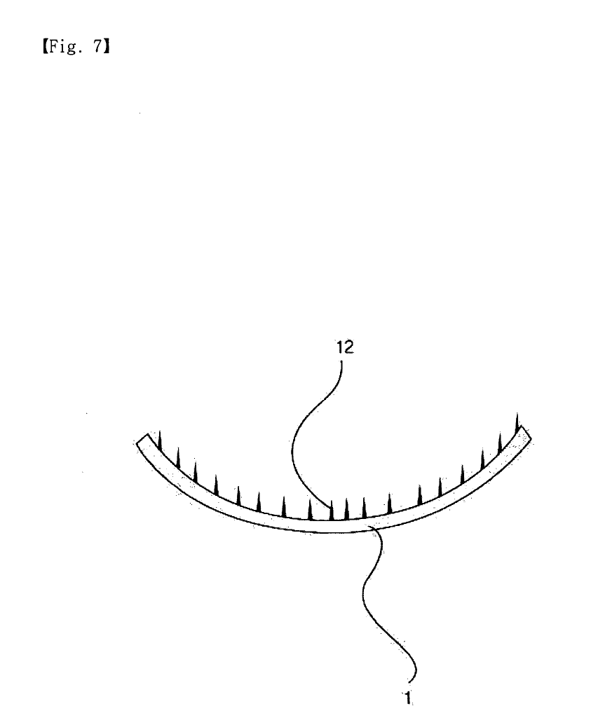

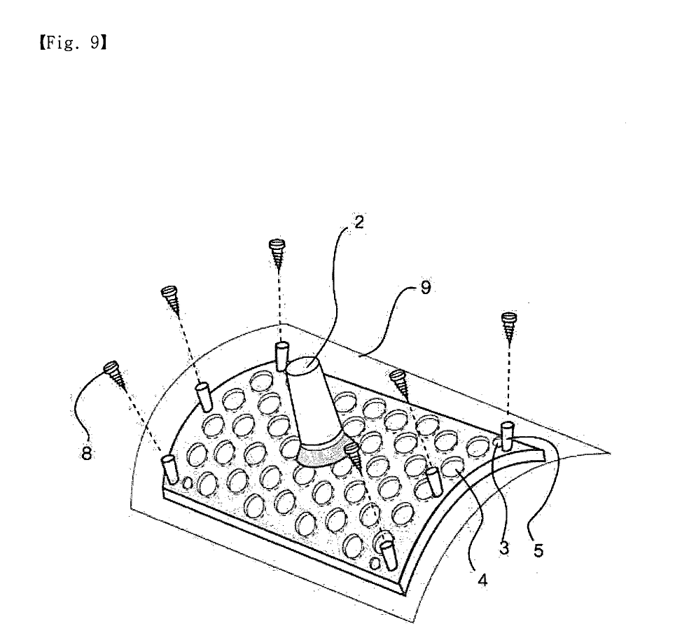

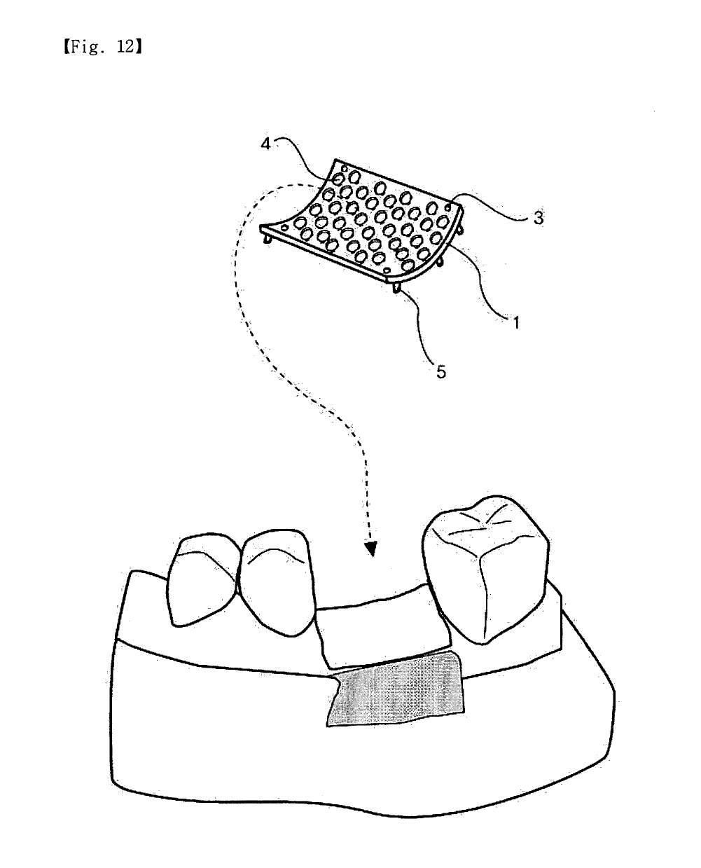

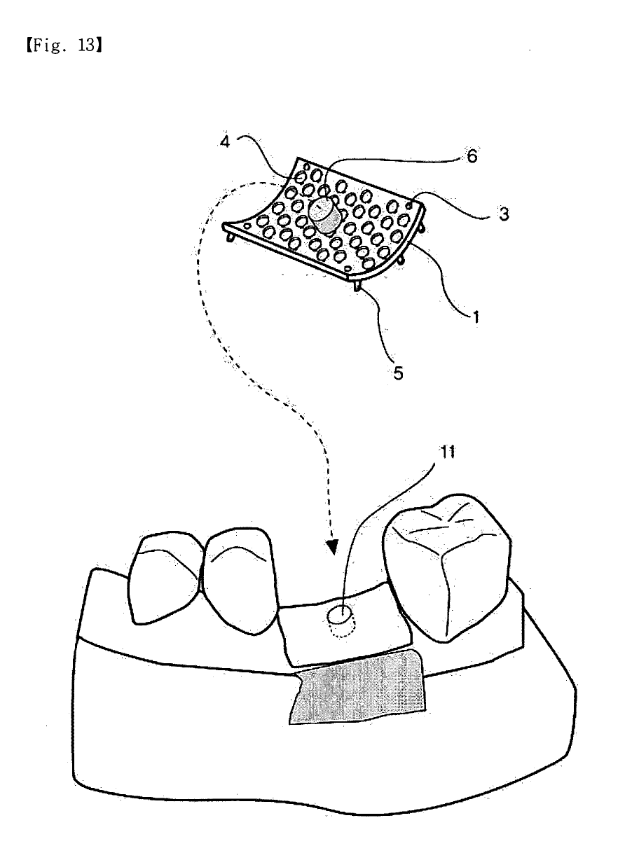

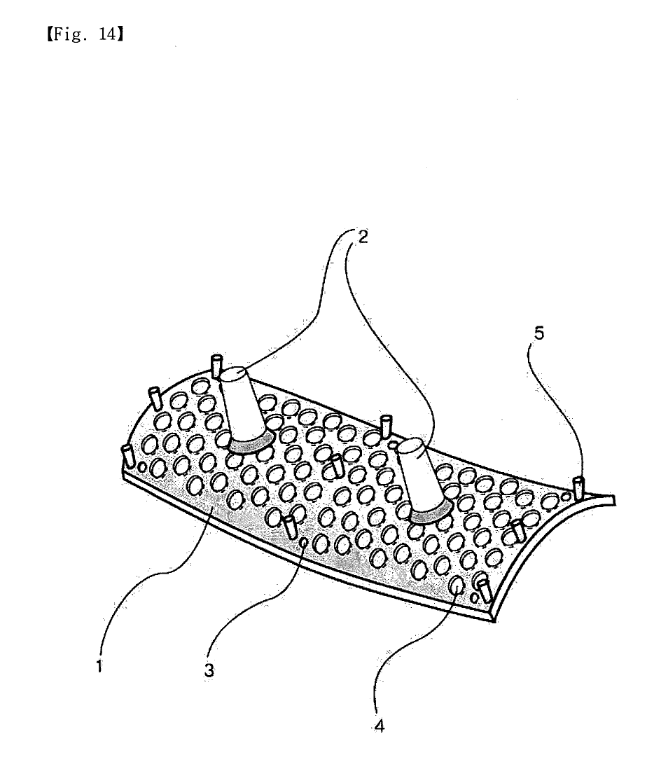

A bottom surface of the mesh plate 1 may have the same shape as a top surface of the alveolar bone so that the mesh plate 1 can be easily loaded on the alveolar bone, as shown in FIGS. 1 to 13. The mesh plate 1 has a plurality of the holes 4.

The mesh plate 1 may also have the plate-fixing holes 3 through which the plate-fixing screws are inserted. The barrier support 5 protrudes from the mesh plate 1 to support the barrier 9 that covers the mesh plate 1. An abutment 2 protrudes from the mesh plate 1 so that an upper implant structure is fixed on the abutment 2.

Hereinafter, a method for installing the dental implant structure will be described.

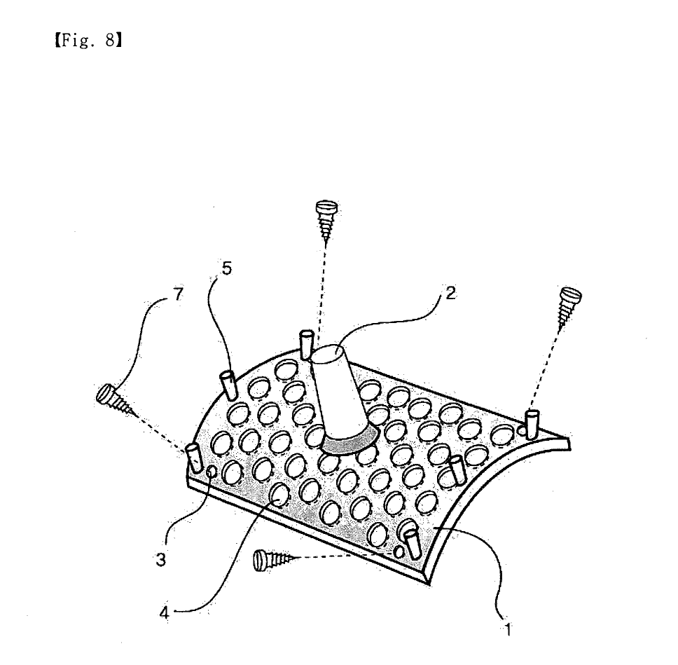

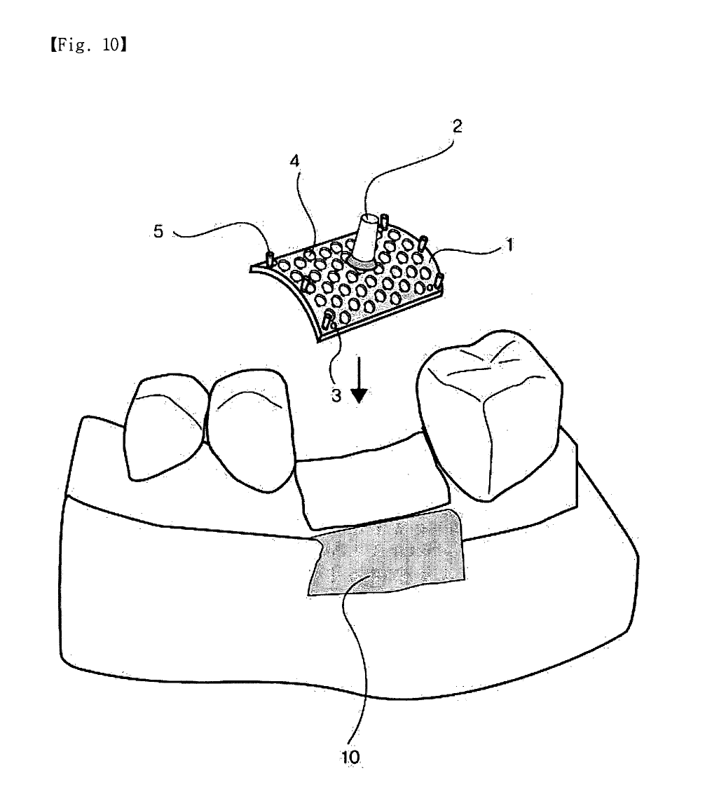

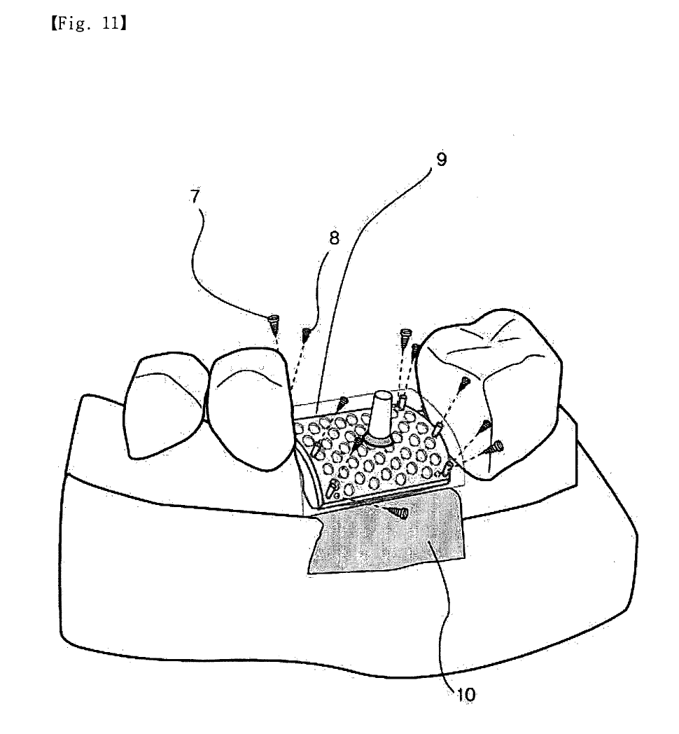

Referring to FIG. 10, a portion of a gingiva 10 is incised to expose the alveolar bone. A mesh plate 1 is loaded on the exposed alveolar bone. A bottom surface of the mesh plate 1 has the same shape as the exposed surface of the alveolar bone so that the mesh plate 1 is easily loaded and stably fixed on the exposed alveolar bone. As shown in FIG. 8, plate-fixing screws 7 are inserted through plate-fixing holes 3 to fix the mesh plate 1 on the alveolar bone. Referring to FIG. 11, a barrier 9 for preventing proliferation of a gingival connective tissue is mounted on barrier supports 5 to cover the mesh plate 1 at a predetermined distance from the mesh plate 1. Barrier-fixing screws are inserted through the barrier 9 into the barrier supports 5 to stably fix the barrier 9 on the barrier supports 5.

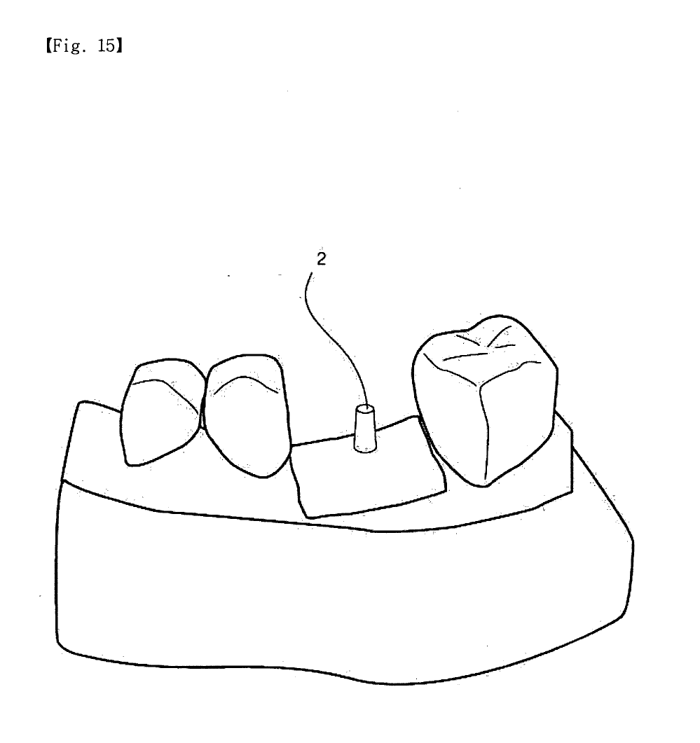

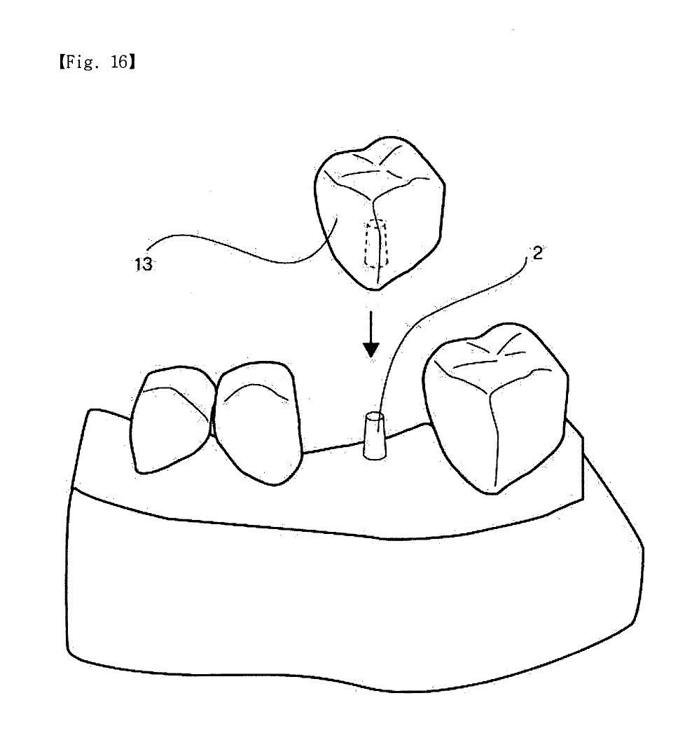

A suture is performed on the gingiva. Then, an abutment 2 protrudes from the gingiva as shown in FIG. 15. Referring to FIG. 16, an upper implant structure is fixed on the abutment 2.

After the suture, a blood clot is formed between the mesh plate 1 and the barrier 9. The blood clot changes to an osseous tissue so that an alveolar bone can be regenerated therefrom. The regenerated alveolar bone strongly supports the mesh plate 1, and thus the upper implant structure.

As described above, the mesh plate 1 is strongly fixed on the alveolar bone because a bottom surface of the mesh plate 1 has the same shape as a top surface of the alveolar bone. However, for a stronger fixation, a fixture 6 may protrude from a bottom of the mesh plate 1 so that the fixture 6 is inserted and fixed in a bore 11 formed in the alveolar bone. In addition, a plurality of wedges having a sharp tip 12 may also be formed on the bottom of the mesh plate 1 to penetrate into the alveolar bone.

While the present invention has been described with respect to the specific embodiments, it will be apparent to those skilled in the art that various changes and modifications may be made without departing from the spirit and scope of the invention as defined in the following claims.

1. A dental implant structure, comprising a mesh plate having a plurality of holes and configured to be loaded on an alveolar bone from which tooth is lost.

2. The dental implant structure of claim 1, further comprising one or more abutments protruding from a top surface of the mesh plate so that an upper implant structure is fixed on the abutments.

3. The dental implant structure of claim 1 or 2, wherein a bottom surface of the mesh plate has a similar shape to a top surface of the alveolar bone.

4. The dental implant structure of claim 1 or 2, further comprising a fixture protruding from a bottom surface of the mesh plate so that the fixture is inserted and fixed in a bore formed in the alveolar bone to facilitate fixation of the mesh plate.

5. The dental implant structure of claim 1 or 2, further comprising a plurality of wedges protruding from a bottom surface of the mesh plate with a sharp tip to facilitate fixation of the mesh plate and induce bleeding.

6. The dental implant structure of claim 1, further comprising a barrier for preventing proliferation of an epithelium and a gingival connective tissue, disposed at a predetermined height from the mesh plate to form a space and easily induce regeneration of an alveolar bone from a blood clot flowed into the space through the plurality of holes.

7. The dental implant structure of claim 6, wherein the barrier is supported by a barrier support and a reinforcement to cover the mesh plate and form a space together with the mesh plate.

8. A mesh plate for a dental implant, having a plurality of holes and configured to be loaded on an alveolar bone from which tooth is lost, a bottom surface of the mesh plate having a similar shape to a top surface of the alveolar bone.
